(19) United States
(12) Patent Application Publication
(10) Pub. No.: US 2025/0262821 A1
(43) Pub. Date: Aug. 21, 2025

(54) Modular Scraping Apparatus and Method

(71) Applicants: Baylin Baskerville-Bridges, San Diego, CA (US); Joshua Ari Ariel, San Diego, CA (US)

(72) Inventors: Baylin Baskerville-Bridges, San Diego, CA (US); Joshua Ari Ariel, San Diego, CA (US)

(21) Appl. No.: 19/056,730

(22) Filed: Feb. 18, 2025

Related U.S. Application Data
(60) Provisional application No. 63/554,928, filed on Feb. 16, 2024.

(51) Int. Cl. B29C 64/245; B29C 64/236; B29C 64/241; B33Y 30/00

(52) U.S. Cl. CPC B29C 64/245; B29C 64/236; B29C 64/241; B33Y 30/00

(57) ABSTRACT

A tilting printing surface formed on a print plate is provided for use in combination with a 3D printer. The printing plate, having a printing surface thereon for forming a printed component with a print head of the 3D printer, is rotatable from a horizontal position to a substantially vertical position. A powered drive may be coupled to the printing plate or a carriage therefor to rotate the print plate from a horizontal position wherein printing may occur thereon to the substantially vertical position wherein gravity will pull upon a printed component to dismount it from the print surface.

### FIELD OF THE INVENTION

This application claims priority to U.S. Provisional Patent Application Ser. No. 63/554,928 filed on Feb. 16, 2024.

The disclosed device relates to 3D printing. More particularly, it relates to a printing surface for 3D printing which rotates to tilt the printing surface to enhance the removal process of the printed component from the printing surface.

### BACKGROUND OF THE INVENTION

The history of 3D printing dates back to the 1980s when it emerged as a revolutionary technology in manufacturing and design. The first 3D printer, capable of building three-dimensional components in a layer by layer formation from a liquid resin, was patented in 1986. In the early years, 3D printing was mainly used for prototyping, allowing engineers and designers to create models and test them without the need for expensive molds or time-consuming production methods.

However, as the technology evolved through the 1990s and 2000s, several different methods of 3D printing were developed, such as selective laser sintering (SLS) and fused deposition modeling (FDM). These and other innovations have expanded the potential applications of 3D printing into industries like aerospace, automotive, and healthcare.

More recently, the technology has begun to gain attention outside of purely industrial sectors as advancements in desktop 3D printers have made the technology more accessible to hobbyists and small businesses. Today, 3D printing is used in a wide range of fields from creating custom prosthetics and architectural models to producing food and even building houses. Its versatility and ability to create complex, customized objects continue to push the boundaries of manufacturing and design.

In virtually all modes of 3D printing, material forming a part or component is deposited upon a printing surface. Once the printer is finished forming the component thereon, it must be removed. This removal process is often a tedious and time-consuming task, requiring manual effort to dislodge the part from the print surface. Operators frequently use tools, such as scrapers or chisels, carefully working to avoid damaging the part or the machine. For high-throughput printing, the repetitive nature of this process can significantly slow down workflow, introduce inconsistencies, and increase labor costs making part removal a major bottleneck in production.

In this respect, before explaining at least one embodiment of the tilting printing surface system herein in detail, it is to be understood that the tilting surface and operation thereof is not limited in its application to the details of construction and to the arrangement of the components set forth in the following description or illustrated in the drawings nor the steps outlined in the specification.

Also, it is to be understood that the phraseology and terminology employed herein are for the purpose of description and should not be regarded as limiting in any manner. As such, those skilled in the art will appreciate that the conception upon which this disclosure is based may readily be utilized as a basis for designing other methods and systems for carrying out the several purposes for the tilting printing surface system for a 3D printer disclosed herein. It is important, therefore, that the claims be regarded as including such equivalent construction insofar as they do not depart from the spirit and scope of the present invention.

### OBJECTS OF THE INVENTION

An object of this invention is the provision of a print surface on a print plate for operative positioning with a 3D printer which is configured to translate and rotate and thereby employ gravity to urge printed components from the printing surface.

An additional object of this invention is the provision of such a print plate with a rotating print surface, which additionally includes a means to urge the component to detach from the printing surface.

A further object of this invention is the provision of such a rotating printing surface on a printing plate employed with a 3D printer, which includes a kinematic coupling to ensure the repeatable positioning of the printing surface to a precise position for forming a printed component thereon.

These, together with other objects and advantages of the disclosed tilting printing surface and system herein, which will become subsequently apparent to those skilled in the art, reside in the details of the device construction and method herein as more fully hereinafter described and claimed, reference being had to the accompanying drawings forming a part thereof, wherein like numerals refer to like parts throughout.

### SUMMARY OF THE INVENTION

The pivoting printing surface system herein provides a tilting print plate having a printing surface on an upper side which is employable in combination with a conventional 3D printer. The print surface on the print plate is pivotally engaged to translate and rotate between a horizontal “as used” positioning, wherein one or a plurality of print heads form a printed component thereon, and a vertical positioning wherein the component is urged to detach automatically and exit the printer housing to a collection container. By vertical positioning herein is meant that the print surface on the print plate is located on an axis running substantially perpendicular to a horizontal axis of the printing surface located in the as-used or printing position. By substantially perpendicular is meant the printing surface in the vertical positioning is at a right angle plus or minus thirty degrees to the print surface in the horizontal positioning whereby gravity will aid in the detachment of a printed part from the print surface.

A primary innovation in the printing surface for a 3D printer herein is the powered pivoting movement of the print plate and print surface thereon, from this horizontal position to the vertical positioning and back to a precise positioning of the print plate and print surface in the horizontal positioning. This precise tilting and positioning may be provided by a powered drive, such as a kinematic coupling of the print plate having the printing surface to the OEM actuators employed to move the print surface relative to the printer and one or more print heads. These conventional actuators may be used to provide the powered drive for powered movement to translate and rotate the carriage and the print plate and printing surface coupled thereto to a vertical positioning and thereafter, to level and orient the print surface in a precise repeatable horizontal printing position or “as used” positioning relative to the motion of one or more printing heads. The printer actuators may be operatively connected to a linear drive mechanism to thereby move the carriage and print surface between the horizontal and vertical positioning. Alternatively, the controlled powered movement of the carriage holding the print surface and coupled with a mount can be provided by a powered drive and may be one such as an electric motor, and the like, engaged with a linear drive such as a worm gear, belt, ribbon, or similar powered linear drive mechanism. As such, by powered drive herein is meant any electric powered drive mechanism which is configured for engagement to the printer plate or carriage to rotate the printer plate between the horizontal position and the vertical position.

The actuators, be they separate powered drives or those included in the 3D printer itself supporting the printing surface on the print plate, may provide for the translation and pivoting or rotation of the print plate and printing surface using a coupling of a support carriage to a linear drive or track providing precise linear movement to the coupled carriage. Currently, this linear drive providing such movement is in a vertical translation. However, it should be noted it could also be in a horizontal movement and push the printing surface to the vertical positioning. By linear drive herein is meant a component configured to provide precise powered linear movement to a mount, to which the carriage is coupled and thereby translate the carriage coupled with the print surface by using a powered drive, such as a stepper motor, a linear electric motor, a rotating geared connection powered by an electric motor, a belt/pulley connection, or screw drives, such as powered worm gears or other highly accurate means for powered translation and accurate positioning of the mount thereon, to which the carriage supporting the print surface is engaged. The linear drive may be engaged with either a support wall, included as a part of the system herein, or can be connected with the housing of the 3D printer in which the system herein is configured for positioning to provide such a support wall.

Printing surfaces herein, in one mode, achieve this highly accurate and repeatable registered positioning of the printing surface to the as-used horizontal positioning through the employment of kinematic couplings which provide for precise positioning of the print plate and printing surface thereon, relative to the printing device and print head or nozzle positioned there above. By kinematic coupling herein is meant that the print plate, having the printing surface thereon and the connections thereto providing the horizontal and vertical movement thereof, are configured to constrain the printer plate and printing surface to a known or registered position, each time it returns to the horizontal printing position, thereby providing precision and certainty of the printing surface location during the 3D printing process.

In operation, the moving carriage communicates a sliding action to position the printer plate and printer surface positioned thereon from the precise horizontal positioning, employed for printing, to a substantially vertical positioning so as to orient the printing surface to employ gravity as a removal aid. The pivoting or tilting print plate and print surface system thereon may include one or more kinematic interfaces which easily decouple and subsequently reseat either on the supports for the print plate or in locations between the print plate and a supported position adjacent or below it. Such kinematic interfaces allow for the gravity-assisted printed component removal process herein, while still protecting the return to the precise registered positioning of the print surface.

Still further, the system herein, without undue mechanical complexity, implements a kinematic positioning apparatus that is capable of decoupling or repositioning for pivoting or rotation and a part detachment and removal and a subsequent repositioning or re-coupling for printing and precise adjustment. This highly accurate or registered positioning is accomplished while concurrently maintaining the rigidity necessary for robust and high quality 3D printing. As such, the printing plate with the printing surface thereon and the carriage and supports for the printing plate are easily employed for operative positioning and use in combination with existing 3D printers either by retrofit or as included in an OEM product.

Finally, the system herein can include additional printed part detachment components and functions, which may be communicated to the printing surface upon reaching a substantially vertical positioning. Such detachment components may include one or a combination of part detachment components from a group including a vibration component, such as a vibration motor or haptic actuator to communicate vibration to the printing surface, a Peltier thermoelectric cooling chip which may communicate heat or cold to the printing surface, or a conduit having cold air supply exiting therefrom directed to contact the printing surface.

With respect to the above description then, it is to be, realized that the dimensional relationships and components of the device and method herein may also include variations in size, materials, shape, form, function and manner of operation, manner of formation, assembly, and use, which are deemed readily apparent and obvious to one skilled in the art subsequent to their review of this specification. Therefore, the foregoing summary and following description should be considered as illustrative only of the principles of the tilting printing surface system for a 3D printing surface invention to provide an easily employable aid in removal of printed components therefrom.

Further, since numerous modifications and changes will readily occur to those skilled in the art, subsequent to their review of this disclosure, it is not desired to limit the invention to the exact construction and operation and steps of formation and employment of the rotating print surface for a 3D printing surface, as shown and described. Accordingly, all suitable modifications and structural and functional equivalents, which may be resorted to, are considered to fall within the scope of the invention.

Further, since numerous modifications and changes will readily occur to those skilled in the art, subsequent to their review of this disclosure, it is not desired to limit the invention to the exact construction and operation and steps of formation and employment of the tilting printing surface system, shown and described. Accordingly, all suitable modifications and structural and functional equivalents, which may be resorted to, are considered to fall within the scope of the invention.

### BRIEF DESCRIPTION OF THE DRAWINGS

The accompanying drawings, which are incorporated herein and form a part of the specification, illustrate some but not the only or exclusive examples of embodiments of the tilting printing surface system herein providing both functional and appearance renewal. It is intended that the embodiments and figures disclosed herein are to be considered illustrative of preferred embodiments of the tilting and translating printing surface device and system rather than limiting.

The accompanying drawings, which are incorporated herein and form a part of the specification, illustrate some but not the only or exclusive examples of embodiments of the tilting printing surface system and assembly for a 3D printing surface herein. It is intended that the embodiments and figures disclosed herein are to be considered illustrative of preferred embodiments of the pivoting or tilting printing surface device and system, rather than limiting.

FIG. 1 depicts the tilting printing surface system herein operatively engaged to work in combination with a conventional 3D printer, showing the printing surface located on the printing plate coupled to a carriage with the printing surface in a horizontal “as used” positioning on which a 3D printer forms a printed component thereon.

FIG. 2 shows the tilting printing surface system of FIG. 1, wherein the printing surface on the surface of the printing plate has been repositioned to a substantially vertical positioning by translation of the carriage whereby gravity aids in the detachment of the printed component.

FIG. 3 is provided as a depiction of the prior art of conventional 3D printers wherein the system herein with the printing plate and printing surface thereon is operatively positioned with the printer in a manner to maintain it while in the horizontal as used position.

FIG. 4 shows the tilting printing surface system, as in FIG. 1.

FIG. 5 depicts the printing plate and printing surface thereon in a pivoting or rotating engagement with a track drive, such as with a translating mount which translates in a linear motion under power from a linear electric motor or an electric motor operatively coupled with a powered belt, rail, or a screw drive, or the like.

FIG. 6 depicts the movement of the printing surface to a substantially vertical positioning.

FIG. 7 shows the tilting printing surface system, as in FIG. 6, wherein the printing plate and printing surface thereon have been elevated.

FIG. 8 shows the detachment of the printed component from the vertically positioned printing surface of FIG. 7.

FIG. 9 shows the printed component exiting the printer housing through an exit opening directly below the vertically positioned printing surface of FIG. 8.

FIG. 10 depicts the tilting printing surface system, as in FIG. 4, wherein the printing surface is in a kinematic coupling with the carriage imparting movement thereto, to provide a certainty of location in the “as used” position of FIGS. 4 and 1, during printing thereon.

FIG. 11 shows the decoupled kinematic printing surface moving from the horizontal position of FIG. 10 toward the positioning of FIG. 12.

FIG. 12 shows the decoupled kinematic printing surface rotated in its engagement to a moving carriage to a vertical positioning.

FIG. 13 shows the printing surface, as in FIG. 12, wherein the printed component thereon is pulled by gravity to start dismounting.

FIG. 14 depicts the printing surface, as in FIG. 13, wherein the printed component has dismounted therefrom.

FIG. 15 shows the exit of the printed component from the housing of the printer through an opening aligned with the printing surface located there above.

FIG. 16 depicts some optional detachment aids which may be included with the system herein to further aid detachment of the printed component from the printing surface.

### DETAILED DESCRIPTION OF THE INVENTION

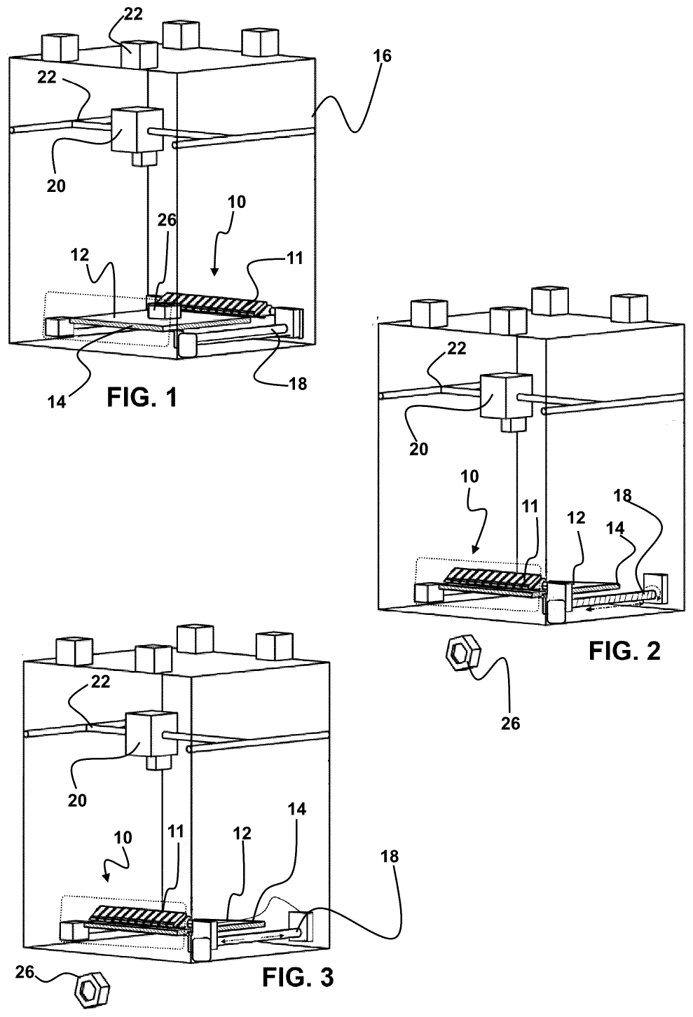

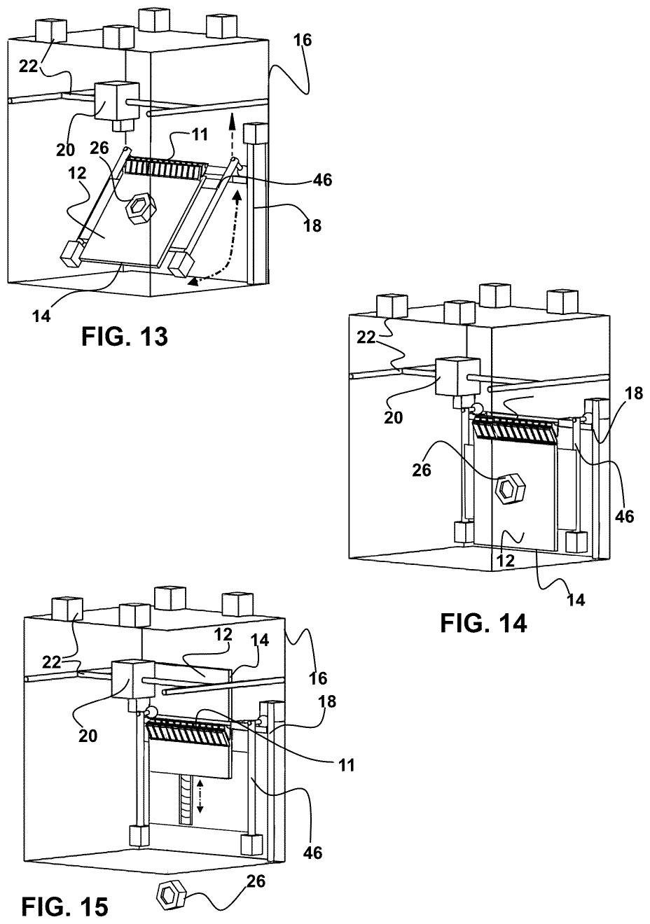

Referring now to the drawings in FIGS. 1-16, there are shown similar components of the tilting printing surface system 10 are identified by like reference numerals. As noted, FIG. 1 depicts the tilting printing surface 12 system 10 herein, operatively engaged to function in combination with a conventional 3D printer, such as shown in FIG. 3. As shown, a printing surface 12 is located on the printing plate 14 in a horizontal “as used” positioning on which the 3D printer 1,1 used in combination herewith, forms a printed component 16 thereon.

In FIG. 2 is depicted a pivoting or tilting of the printing surface system 10 of FIG. 1, wherein the printing surface 12 on one side of the printing plate 14 is coupled to a powered drive to move between the horizontal position and the vertical position. Such a coupling may be, as shown, to a carriage 18, which moves to the substantially vertical positioning whereby the force of gravity will aid in the detachment of the printed component 16. The coupling of the printer plate 14 to the carriage 18 may be with a support member 17 or a similar means for holding the support plate 14 securely to the carriage 18.

The carriage 18 is in pivoting coupling 19, such as a mount 24, for the depicted linear drive 22 such that the carriage 18 and the first end of the print plate 14 will pivot in that coupling as it moves from the horizontal positioning of FIG. 1 to the substantially vertical positioning of FIG. 2. While shown with two powered or linear drives 22 on opposing sides of the carriage 18, coupled either with the 3D printer actuators 15 or a powered drive 13, the system 10 may be configured with at least one powered or linear drive 22 coupled with a moving mount 24 sliding upon a track or race 25 (FIG. 10) or other support for the opposite side of the carriage 18. Additionally, as noted, the force for moving the printing surface 12 between the horizontal position and the vertical position may also be provided by the conventional actuators 15 already on or used by such 3D printers to move the print head 20 and other components thereof. As such, the powered drive 13 may be the printer actuators 15 since they are already computer controlled to provide powered movement.

The drawing of FIG. 3 is provided as a prior art depiction of well known conventional 3D printers 11 which employ a moving printer head or nozzle 20 to form a printed component 16 upon the printing surface 12 of a printing plate 14. As noted, the system 10 herein is positionable for use in combination with such a 3D printer 11. By positionable is meant the system 10 herein may be easily retrofitted to existing 3D printers 11 wherein the pivoting printer plate 14 and print surface 12 is operatively located below the print head 20, or it may be included as part of newly manufactured or OEM 3D printers 11 in such an operative positioning.

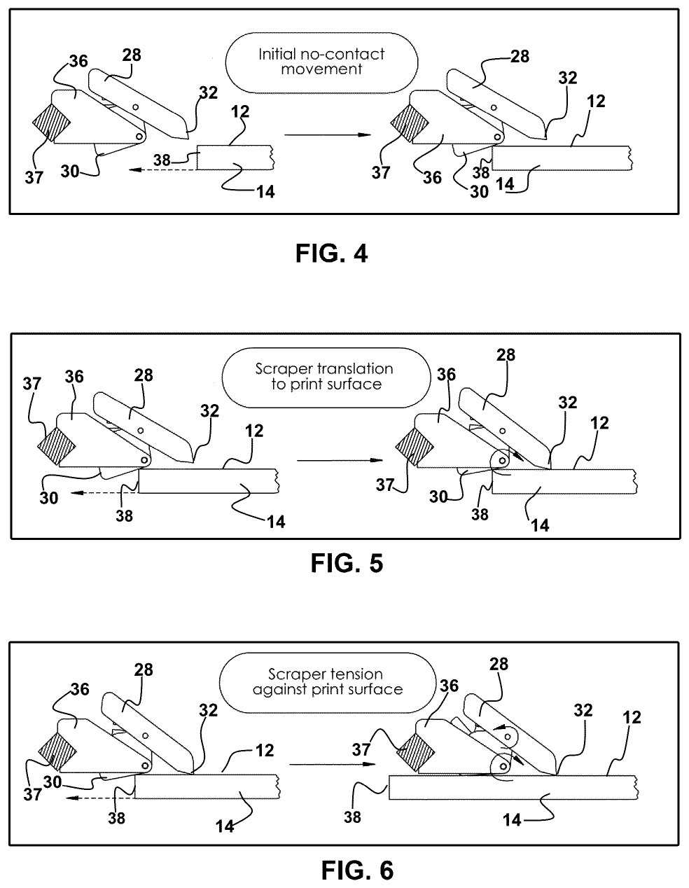

Shown in FIGS. 4-8 are the system 10 herein positioned to operate with the pivoting or tilting print surface 12 located on a print plate 14, where the print surface 12 will move between the horizontal or as used position of FIG. 4 and the substantially vertical positioning of FIGS. 8-9. From the horizontal or as used positioning of FIG. 4, once the printed component 16 is completed upon the printing surface 12 by the 3D printer 11, in which the system herein is configured for positioning, a pivoting of the printing surface 12 toward the vertical positioning is initiated, as shown in FIG. 5.

The printing surface 12 is located on the printing plate 14 which is coupled to the powered or linear drive 22 providing the force to move the printing surface 12 between the horizontal and vertical positions by a carriage 18. Preferably, this coupling of the printing plate 14 with the printing surface 12 thereon is a kinematic coupling wherein the print surface 12 will continuously be repositioned when located to the horizontal or as used positioning of FIG. 4 to a known or exact positioning below a printer head 20, when the system 10 is located within a 3D printer 11. Such will thereby provide high repeatability and precision each time the printing surface 12 is relocated to the horizontal or as used positioning of FIGS. 4 and 10.

Currently, the pivoting or tilting action for the printing surface 12 to reach the substantially vertical positioning of FIGS. 6-9 and back again is provided by the coupling of the printing surface 12 to a pivotally coupled component, such as to the carriage 18. The carriage 18 is pivotally coupled to a powered drive which provides the force and direction of movement to rotate the carriages 18 and engaged printer plate 14 between the horizontal and substantially vertical positions.

By powered drive herein is meant an electric powered drive which is configured for engagement with the printing plate 14 or carriage and is actuated to move them between the horizontal position and the vertical position as required.

For example and in no way limiting, a translating or moving mount 24, operatively engaged with a powered drive, such as a linear drive 22, as those noted above, may provide the powered drive. Such a linear drive 22 will translate the mount 24 to which the printing surface 12 is coupled by the carriage 18 which pivotally engages the mount 24 to provide precise repeatable positions for the printing surface 12. This provides for the tilting of the printing surface 12 between the precise horizontal printing positioning or the as used positions, such as in FIGS. 4 and 10 and the vertical positions, as in FIGS. 6-9.

As noted, the linear drive 22 or other means for pivoting the printer plate and printing surface 12 may be coupled to a fixed support such as support wall 23 provided with the system 10 herein, or it may be engaged with the housing 26, either directly or to a mount connected to the house, so long as it is fixed in position.

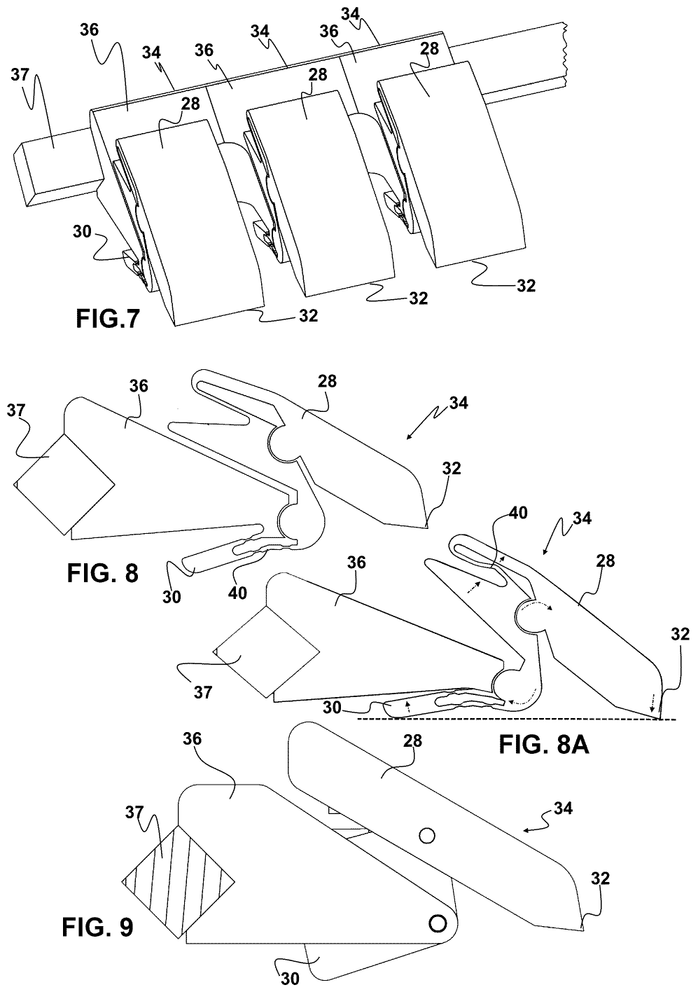

FIG. 8 shows the detachment of the printed component from the vertically positioned printing surface of FIG. 7. Once in the vertical positioning, such as in FIGS. 9 and 15, the force of gravity will aid in the detachment of the printed component 16. So detached, the printed component 16 may exit the printer housing 26 through an exit opening 28, positioned below the vertically positioned printing surface 12 of FIG. 9.

FIGS. 10-15 show the system 10 herein in the same movement and positioning as that of FIGS. 4-9 but are shown to include an enhanced kinematic coupling of the printing plate 14 and printing surface 12 thereon, with the carriage 18 and the printer 11 in which the system 11 is configured for positioning and use. As shown, a support mount 30 is configured to support a second end of the printing plate 14 opposite the first end thereof which is coupled to the mount 24 of the linear drive 22.

The support mount 30 may be engaged to a fixed surface or position at a first end thereof. By fixed surface herein is meant a surface which is stationary and does not move, such as the printer housing or member or support connected thereto, whereby the support mount 30 is fixed in position. The distal end of the secondary mount 30 is configured to form a support contact with the printer plate 14 when it and the print surface 12 are in the horizontal or as used position, such as in FIGS. 4 and 10, where printed components 16 are formed thereon.

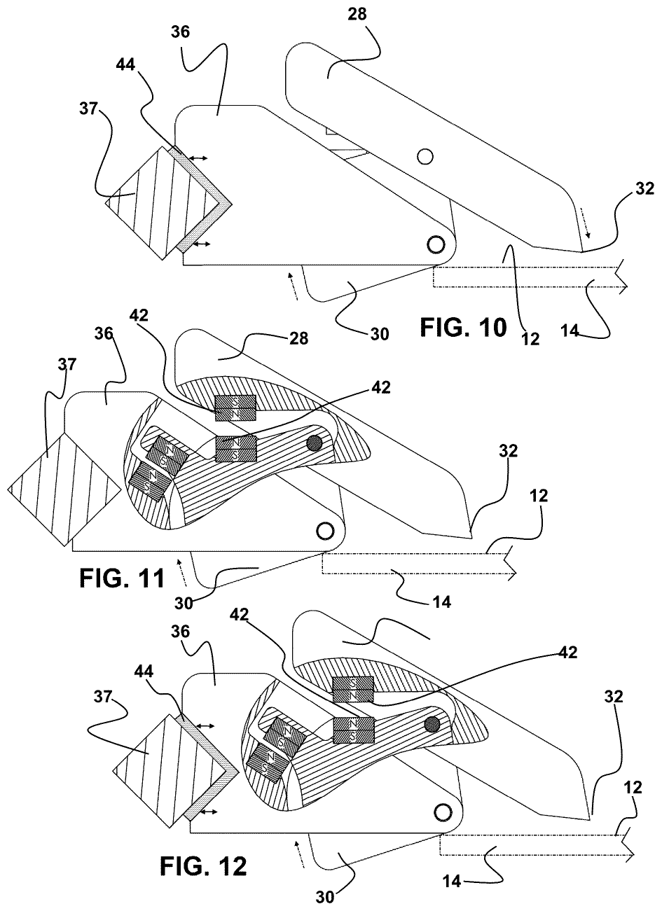

This distal end of the secondary mount 30 may include a ball 32 which is positioned within a socket 34 located upon the printer plate 14. Additionally, to enhance the kinematic coupling of the printer plate 14 and print surface 12 thereon to the carriage 18 and the 3D printer, the pivoting coupling 19 of the first end of the printer plate 14 to the mount 24 may include a secondary socket 36 formed on one of the mount 24 or the end of the carriage 18, with a secondary ball 38, formed on the other of the mount 24 or carriage 18, as shown in FIG. 11.

FIG. 15 shows the exit of the printed component 16 from the housing 26 of the printer 11 through an opening 28 aligned with the vertically positioned printing surface 12 located there above.

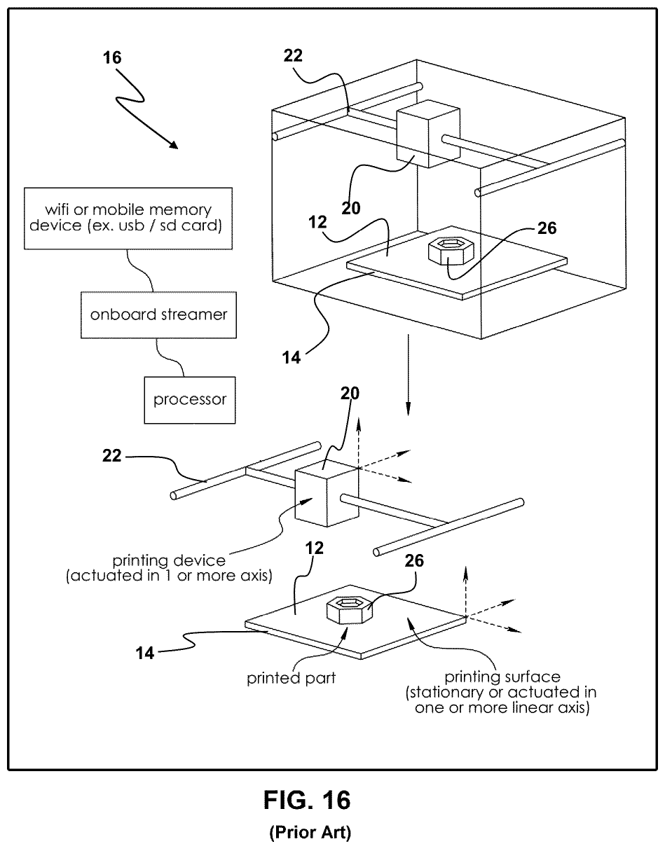

Shown in FIG. 16 are depictions of some optional detachment components which may be included with the system 10 herein. Such detachment components may be connected to the support wall 23, when present, or to a lower side of the printer plate 14 opposite the printing surface 12. They are preferably electrically powered by the onboard power of the printer to which the system 10 herein is positionable which would be accomplished by electric connections thereto.

Such detachment components may be one or a combination of secondary detachment components from a group of secondary detachment components including a vibration component, such as a vibration motor or haptic actuator to communicate vibration 40 to the printing surface 12, a Peltier thermoelectric cooling chip 42 which may communicate heat or cold to the printing surface, a liquid cooled area 43, or a conduit 44, having a cold air supply exiting therefrom directed to contact the printing surface 12. Once the printing surface 12 and print plate 14 reach the substantially vertical positioning of FIGS. 9 and 15, the detachment components may be employed to assist in the release of the printed component 16 from the print surface 12. This may be achieved by means of thermal variation, wherein the thermoelectric module 42 or conduit 44 induces cooling to lower any adhesion between the printed component 16 and the printing surface 12 or by means of vibration using the vibrator 40 to break any adhesion between the printed component 16 and the print surface 12. Such actions will aid gravity in detaching the printed component 16 from the printing surface 12 whereby it will fall through the exit opening 28 for collection.

As noted above, while the present tilting printing surface and system 10 invention has been described herein with reference to particular embodiments thereof and steps in the method of employment of the modes thereof, a latitude of modifications, various changes and substitutions are intended in the foregoing disclosures, it will be appreciated that in some instances some features or steps in a configuration of the tilting printing surface invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office and the public generally, and especially the scientists, engineers, and practitioners in the art, who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A tilting print surface for positioning within a 3D printer, comprising:
a printer plate having a print surface thereon for formation of a printed component thereon;
said printer plate in a pivoting coupling to a support at or adjacent a first end of said printer plate;
said printer plate having a horizontal positioning locating said print surface below a print head of said 3D printer; and
said printer plate moveable from said horizontal position to a substantially vertical position wherein, subsequent to a formation of a component upon said print surface by said print head, a pivoting of said printer plate to said substantially vertical position aids in the detachment of said printed component from said print surface.

2. The tilting print surface for positioning within a 3D printer of claim 1 additionally comprising:
a carriage supporting said printer plate;
said carriage in said pivoting coupling to said support;
a powered drive engaged with said carriage;
said powered drive actuable to rotate said carriage between a horizontal positioning thereof and a vertical positioning thereof;
said horizontal positioning of said carriage locating said printer plate to said horizontal positioning thereof; and
said vertical positioning of said carriage locating said printer plate to said substantially vertical positioning thereof.

3. The tilting print surface for positioning within a 3D printer of claim 2 wherein said powered drive comprises:
a linear drive;
a coupling at a first end of said carriage to said linear drive;
said linear drive powered by an electric motor; and
said linear drive actuable to translate said carriage between said horizontal positioning thereof and said vertical positioning thereof.

4. The tilting print surface for positioning within a 3D printer of claim 1 additionally comprising:
a second mount;
said second mount having a first end engaged to a fixed position;
said second mount having a second end; and
said second end forming a removable contact with a lower surface of said printer plate at a contact point adjacent a second end thereof opposite said first end thereof, with said printer plate located in said horizontal position thereof.

5. The tilting print surface for positioning within a 3D printer of claim 2 additionally comprising:
a second mount;
said second mount having a first end engaged to a fixed position;
said second mount having a second end; and
said second end forming a removable contact with a lower surface of said printer plate at a contact point adjacent a second end thereof opposite said first end thereof, with said printer plate located in said horizontal position thereof.

6. The tilting print surface for positioning within a 3D printer of claim 3 additionally comprising:
a second mount;
said second mount having a first end engaged to a fixed position;
said second mount having a second end; and
said second end forming a removable contact with a lower surface of said printer plate at a contact point adjacent a second end thereof opposite said first end thereof, with said printer plate located in said horizontal position thereof.

7. The tilting print surface for positioning within a 3D printer of claim 4 additionally comprising:
a ball at said second end of said second mount; and
a recess for receiving said ball positioned at said contact point.

8. The tilting print surface for positioning within a 3D printer of claim 5 additionally comprising:
a ball at said second end of said second mount; and
a recess for receiving said ball positioned at said contact point.

9. The tilting print surface for positioning within a 3D printer of claim 6 additionally comprising:
a ball at said second end of said second mount; and
a recess for receiving said ball positioned at said contact point.

10. The tilting print surface for positioning within a 3D printer of claim 1 additionally including:
a secondary detachment component positioned adjacent to said printer plate while in said substantially vertical position; and
said secondary detachment component being one or a combination of secondary detachment components from a group of secondary detachment components including, a vibration component to communicate vibration to the printing surface, a thermoelectric cooling chip for communicating heat or cold therefrom to the printing surface, a liquid cooled area, and a conduit having a cold air supply exiting therefrom directed to contact the printing surface.

11. The tilting print surface for positioning within a 3D printer of claim 2 additionally including:
a secondary detachment component positioned adjacent to said printer plate while in said substantially vertical position; and
said secondary detachment component being one or a combination of secondary detachment components from a group of secondary detachment components including, a vibration component to communicate vibration to the printing surface, a thermoelectric cooling chip for communicating heat or cold therefrom to the printing surface, a liquid cooled area, and a conduit having a cold air supply exiting therefrom directed to contact the printing surface.

12. The tilting print surface for positioning within a 3D printer of claim 3 additionally including:
a secondary detachment component positioned adjacent to said printer plate while in said substantially vertical position; and
said secondary detachment component being one or a combination of secondary detachment components from a group of secondary detachment components including, a vibration component to communicate vibration to the printing surface, a thermoelectric cooling chip for communicating heat or cold therefrom to the printing surface, a liquid cooled area, and a conduit having a cold air supply exiting therefrom directed to contact the printing surface.

13. The tilting print surface for positioning within a 3D printer of claim 5 additionally including:
a secondary detachment component positioned adjacent to said printer plate while in said substantially vertical position; and
said secondary detachment component being one or a combination of secondary detachment components from a group of secondary detachment components including, a vibration component to communicate vibration to the printing surface, a thermoelectric cooling chip for communicating heat or cold therefrom to the printing surface, a liquid cooled area, and a conduit having a cold air supply exiting therefrom directed to contact the printing surface.

14. The tilting print surface for positioning within a 3D printer of claim 6 additionally including:
a secondary detachment component positioned adjacent to said printer plate while in said substantially vertical position; and
said secondary detachment component being one or a combination of secondary detachment components from a group of secondary detachment components including, a vibration component to communicate vibration to the printing surface, a thermoelectric cooling chip for communicating heat or cold therefrom to the printing surface, a liquid cooled area, and a conduit having a cold air supply exiting therefrom directed to contact the printing surface.

15. The tilting print surface for positioning within a 3D printer of claim 8 additionally including:
a secondary detachment component positioned adjacent to said printer plate while in said substantially vertical position; and
said secondary detachment component being one or a combination of secondary detachment components from a group of secondary detachment components including, a vibration component to communicate vibration to the printing surface, a thermoelectric cooling chip for communicating heat or cold therefrom to the printing surface, a liquid cooled area, and a conduit having a cold air supply exiting therefrom directed to contact the printing surface.

16. The tilting print surface for positioning within a 3D printer of claim 9 additionally including:
a secondary detachment component positioned adjacent to said printer plate while in said substantially vertical position; and
said secondary detachment component being one or a combination of secondary detachment components from a group of secondary detachment components including, a vibration component to communicate vibration to the printing surface, a thermoelectric cooling chip for communicating heat or cold therefrom to the printing surface, a liquid cooled area, and a conduit having a cold air supply exiting therefrom directed to contact the printing surface.

17. A tilting print surface for a 3D printer, comprising:
a 3D printer having a print head for forming a printed component;
a printer plate having a print surface thereon for formation of said printed component thereon;
said printer plate in a pivoting coupling to a support at or adjacent a first end of said printer plate;
said printer plate having a horizontal positioning locating said print surface below a print head of said 3D printer; and
said printer plate moveable from said horizontal position to a substantially vertical position wherein, subsequent to a formation of a component upon said print surface by said print head, a pivoting of said printer plate to said substantially vertical position aids in the detachment of said printed component from said print surface.

18. The tilting print surface for a 3D printer of claim 17 additional, comprising:
a carriage supporting said printer plate;
said carriage in said pivoting coupling to said support;
a powered drive engaged with said carriage;
said powered drive actuable to rotate said carriage between a horizontal positioning thereof and a vertical positioning thereof;
said horizontal positioning of said carriage locating said printer plate to said horizontal positioning thereof; and
said vertical positioning of said carriage locating said printer plate to said substantially vertical positioning thereof.
